(19) United States
(12) Patent Application Publication
(10) Pub. No.: US 2007/0059636 A1
(43) Pub. Date: Mar. 15, 2007

(54) Light sensitive planographic printing plate material

(75) Inventor: Takaaki Kuroki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/511,148

(22) Filed: Aug. 28, 2006

(30) Foreign Application Priority Data
Sep. 12, 2005 (JP) JP2005-263517

(51) Int. Cl. G03C 1/00

(52) U.S. Cl. 430/270.1

(57) ABSTRACT

Disclosed is a light sensitive planographic printing plate material comprising a support and provided thereon, a light sensitive layer, wherein the light sensitive layer contains a polymerizable ethylenically unsaturated compound, a photopolymerization initiator, a polymeric binder, a sensitizing dye, and a copolymer having a first unit represented by formula (1), a second unit represented by formula (2) and a third unit represented by formula (3), Formula (1) Formula (2)

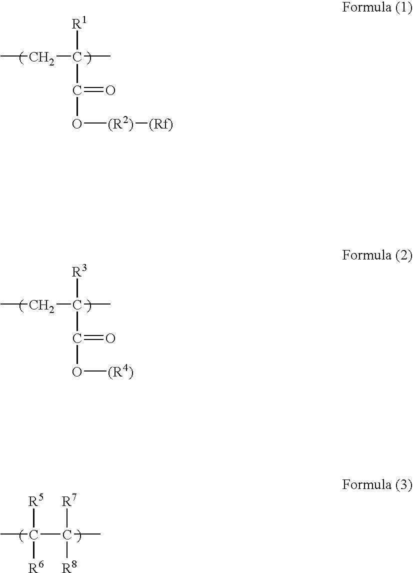

This application is based on Japanese Patent Application No. 2005-263517, filed on Sep. 12, 2005 in Japanese Patent Office, the entire content of which is hereby incorporated by reference.

### FIELD OF THE INVENTION

The present invention relates to a light sensitive planographic printing plate material used in a computer to plate system (hereinafter also referred to as CTP).

### BACKGROUND OF THE INVENTION

In recent years, in a plate-making process of a printing plate for off-set printing, CTP, which records digital image data directly on a light sensitive printing plate material employing laser light, has been developed and practically used.

As the printing plate materials used for CTP, there are a negative-working thermal printing plate material as disclosed, for example, in Japanese Patent O.P.I. Publication No. 11-84649, which comprises a light sensitive layer containing a novolak resin, a cross-linking agent, a photolytically acid generating agent, and an infrared absorbing dye, and a positive-working thermal printing plate material as disclosed, for example, in Japanese Patent O.P.I. Publication No. 10-268512, which comprises a light sensitive layer containing a light-to-heat conversion material, an alkali-soluble resin, and a dissolution-inhibiting agent.

It is commonly known that of printing plate materials used for CTP, a negative working light sensitive planographic printing plate material comprising a polymerizable light sensitive layer containing a polymerizable compound is used in printing fields in which relatively high printing durability is required (see for example, Japanese Patent O.P.I. Publication No. 10-104835).

The planographic printing plate material comprising a polymerizable light sensitive layer has problem in that the light sensitive layer reduces sensitivity due to oxygen, resulting in lowering of storage stability. As a method to minimize the influence of oxygen, it is well known that an oxygen-shielding layer (protective layer) is provided on the light sensitive layer.

As a method providing an oxygen-shielding layer, there are a method providing a protective layer containing polyvinyl alcohol and a vinyl pyrrolidone copolymer containing 40 mol% or more of a vinyl pyrrolidone unit and having a weight average molecular weight of from 10,000 to 500,000 (see Japanese Patent O.P.I. Publication No. 2002-169272) and a method providing an oxygen-shielding layer containing polyvinyl acetate having an average saponification degree of from 70% to less than 85% and polyvinyl acetate having an average saponification degree of from 85% to less than 100% (see Japanese Patent O.P.I. Publication No. 9-204049).

Known is a light sensitive planographic printing plate material comprising a light sensitive layer containing a copolymer of acrylate having a fluoroalkyl group and poly(oxyalkylene) acrylate, whereby a light sensitive layer with a uniform thickness is obtained (see Japanese Patent o.P.I. Publication No. 62-226143). Further, known is a resist composition containing a fluorine-contained surfactant such as a copolymer containing a fluorinated alkyl group-containing acrylate for forming a coating with a uniform thickness (see Japanese Patent O.P.I. Publication No. 62-36657).

However, these printing materials have problems in that sensitivity is insufficient, and storage stability is insufficient, for example, stain occurs after storage, although direct laser writing is possible. The printing plate materials having an oxygen-shielding layer have problems in that adhesion of the oxygen-shielding layer to the light sensitive layer is poor, which causes image formation faults resulting from exfoliation of the oxygen-shielding layer. These techniques have proven difficult to overcome the problems without lowering sensitivity and dot reproduction.

### SUMMARY OF THE INVENTION

An object of the invention is to provide a light sensitive planographic printing plate material providing good coatability, excellent adhesion of an oxygen-shielding layer, high sensitivity, high dot reproduction, wide preheating latitude, and excellent anti-sludge contamination properties.

### DETAILED DESCRIPTION OF THE INVENTION

The above object of the present invention can be attained by the following constitution.

1. A light sensitive planographic printing plate material comprising a support and provided thereon, a negative working light sensitive layer, wherein the light sensitive layer contains a polymerizable ethylenically unsaturated compound, a photopolymerization initiator, a polymeric binder, a sensitizing dye, and a copolymer having a first unit represented by formula (1), a second unit represented by formula (2), and a third unit represented by formula (3), 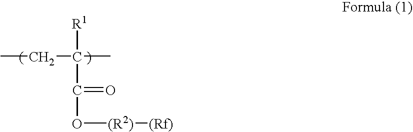
wherein R¹ represents a hydrogen atom or an alkyl group having a carbon atom number of from 1 to 3; R² represents a divalent linkage group, and Rf represents a perfluoroalkyl group or a perfluoroalkenyl group, 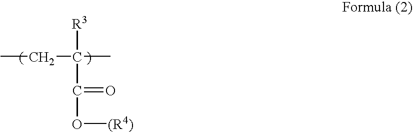
wherein R³ represents a hydrogen atom or an alkyl group having a carbon atom number of from 1 to 3; and R⁴ represents a substituted or unsubstituted alkyl group or a substituted or unsubstituted cycloalkyl group, 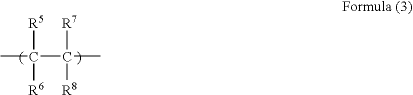
wherein R⁵, R⁶, R⁷ and R⁸ independently represent a hydrogen atom, a methyl group or R⁹, provided that at least one of R⁵, R⁶, R⁷ and R⁸ is R⁹, where R⁹ represents a carboxyl group, a sulfonic acid group, a carboxylate group, a sulfonate group, or a substituent having a carboxyl group, a sulfonic acid group, a carboxylate group, a sulfonate group, —(C₂H₄O)pH, or —(C₃H₆O)qH, in which p and q independently represent an integer of from 1 to 50.

2. The light sensitive planographic printing plate material of item 1 above, wherein the photopolymerization initiator is a biimidazole compound or an iron arene complex.

3. The light sensitive planographic printing plate material of item 1 above, wherein the sensitizing dye has absorption maximum in the wavelength regions of from 350 to 450 nm.

4. The light sensitive planographic printing plate material of item 1 above, wherein the sensitizing dye is a coumarin dye represented by the following formula (8), 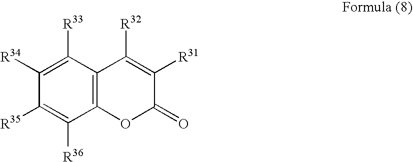
wherein R⁻, R³² R³³ R³⁴ R³⁵ and R³⁶ independently represent a hydrogen atom or a substituent.

5. The light sensitive planographic printing plate material of item 1 above, further comprising an oxygen-shielding layer containing a hydrophilic polymer on the light sensitive layer, the oxygen-shielding layer being an outermost layer.

6. The light sensitive planographic printing plate material of item 5 above, wherein the oxygen-shielding layer contains, as the hydrophilic polymer, polyvinyl alcohol having a saponification degree of from 90 to 100 mol %.

7. The light sensitive planographic printing plate material of item 6 above, wherein the oxygen-shielding layer further contains polyvinyl pyrrolidone.

8. The light sensitive planographic printing plate material of item 1 above, wherein the content of the first unit, the content of the second unit and the content of the third unit in the copolymer is from 30 to 50 mol %, from 20 to 40 mol %, and from 20 to 40 mol %, respectively.

9. The light sensitive planographic printing plate material of item 1 above, wherein the content of the polymerizable ethylenically unsaturated compound is from 30 to 70% by weight, the content of the polymeric binder is from 15 to 70% by weight, the content of the sensitizing dye is from 0.1 to 20% by weight, and the content of the copolymer is from 0.01 to 10% by weight, each based on the weight of light sensitive layer, and the content of the photopolymerization initiator is from 0.1 to 20% by weight based on the weight of the ethylenically unsaturated compound.

10. A light sensitive planographic printing plate material comprising a support and provided thereon, a positive working light sensitive layer, wherein the light sensitive layer contains a photolytically acid generating agent, an acid decomposable compound, an infrared absorbing dye, and a copolymer having a first unit represented by formula (1) above, a second unit represented by formula (2) above and a third unit represented by formula (3) above.

11. The light sensitive planographic printing plate material of item 9 above, wherein the content of the first unit, the content of the second unit and the content of the third unit in the copolymer is from 30 to 50 mol %, from 20 to 40 mol %, and from 20 to 40 mol %, respectively.

12. The light sensitive planographic printing plate material of item 10 above, wherein the photolytically acid generating agent is selected from the group consisting of a salt of diazonium, phosphonium, sulfonium or iodonium ion with BF₄⁻, PF₆⁻, SbF₆⁻SiF₆²⁻or ClO₄⁻, an organic halogen-containing compound, and o-quinonediazide sulfonylchloride.

13. The light sensitive planographic printing plate material of item 10 above, wherein the light sensitive layer further contains a polymeric binder.

14. The light sensitive planographic printing plate material of item 13 above, wherein the content of the photolytically acid generating agent is from 0.1 to 20% by weight, the content of the acid decomposable compound is from 5 to 70% by weight, the content of the infrared absorbing dye is from 0.5 to 10% by weight, the content of the copolymer is from 0.01 to 10% by weight, and the content of the polymeric binder is from 15 to 70% by weight, each based on the weight of the light sensitive layer.

### EFFECTS OF THE INVENTION

The light sensitive planographic printing plate material of the invention has advantageous effects of the invention that provide good coatability, excellent adhesion of an oxygen-shielding layer, high sensitivity, high dot reproduction, wide preheating latitude, and excellent anti-sludge contamination properties, and that provide good removability of interleaves inserted between adjacent two in the light sensitive printing plate materials stacked.

The present invention will be explained below.

The light sensitive planographic printing plate material of the invention, comprising a support and a light sensitive layer provided thereon, is characterized in that the light sensitive layer contains a copolymer (hereinafter also referred to as the copolymer in the invention) having a first unit represented by formula (1), a second unit represented by formula (2), and a third unit represented by formula (3). The copolymer having a first unit represented by formula (1), a second unit represented by formula (2) and a third unit represented by formula (3) will be explained below.

In formula (1), R¹ represents a hydrogen atom or an alkyl group having a carbon atom number of from 1 to 3. Examples of the alkyl group having a carbon atom number of from 1 to 3 include a methyl group, an ethyl group, and a propyl group. R¹ is preferably a hydrogen atom or a methyl group. R² represents a divalent linkage group. The divalent linkage group represents a substituted or unsubstituted alkyl group, a substituted or unsubstituted alkyleneoxy group, a substituted or unsubstituted alkyleneoxyalkylene group, or a substituted or unsubstituted alkyleneiminosulfonyl group. Typical examples of the divalent linkage group include ethylene, ethyleneoxy, and 2-hydroxyethylene. Rf represents a perfluoroalkyl group or a perfluoroalkenyl group. The carbon atom number of the perfluoroalkyl or perfluoroalkenyl group is preferably from 2 to 20, more preferably from 3 to 12, and most preferably from 3 to 6.

In formula (2), R³ represents a hydrogen atom or an alkyl group having a carbon atom number of from 1 to 3. R³ is preferably a hydrogen atom or a methyl group. R⁴ represents a substituted or unsubstituted alkyl group or a substituted or unsubstituted cycloalkyl group. Examples of R⁴ include a lower alkyl group such as a methyl group, an ethyl group, a propyl group, a butyl group or a pentyl group, and a cyclohexyl group.

In formula (3), R⁵, R⁶, R⁷ and R⁸ independently represent a hydrogen atom, a methyl group or R⁹, provided that at least one of R⁵, R⁶, R⁷ and R⁸ represents R⁹, where R⁹ represents a carboxyl group, a sulfonic acid group, a carboxylate group (for example, —COOM in which M is an alkali atom), a sulfonate group (for example, —SO₃M in which M is an alkali atom), a substituent having a carboxyl group, a sulfonic acid group, a carboxylate group or a sulfonate group, or a substituent having —(C₂H₄O)pH, or —(C₃H₆O)qH, in which p and q independently represent an integer of from 1 to 50. It is preferred that p and q independently represent an integer of from 1 to 10.

Examples of the substituent having a carboxyl group, a sulfonic acid group, a carboxylate group or a sulfonate group include an alkyl group having a carboxyl group or a sulfonic acid group, 3-sodiumsulfophenyl, —CO(NH)C(CH₃)₂CH₂SO₃M, and —CH₂SO₃M, in which M represents an alkali metal atom.

Examples of the substituent having —(C₂H₄O)pH or —(C₃H₆O)qH include —COO(C₂H₄O)₄H, —COO—(C₂H₄O)₆H, and —COO (C₃H₆O) H.

The copolymer in the invention has a weight average molecular weight of preferably from 3000 to 70,000, and more preferably from 5000 to 50,000.

The copolymer in the invention has in the molecule a first unit represented by formula (1), a second unit represented by formula (2) and a third unit represented by formula (3), and optionally another unit. When x, y and z represents a content (by mol %) in the copolymer of the first unit, a content (by mol %) in the copolymer of the second unit, and a content (by mol %) in the copolymer of the third unit, respectively, the sum of x, y and z is preferably 100. In the copolymer in the invention, x is preferably from 30 to 50, y is preferably from 20 to 40, and z is preferably from 20 to 40.

Examples of the copolymer in the invention will be listed below. The subscript in each of the monomer units constituting the copolymer listed below represents mol %.

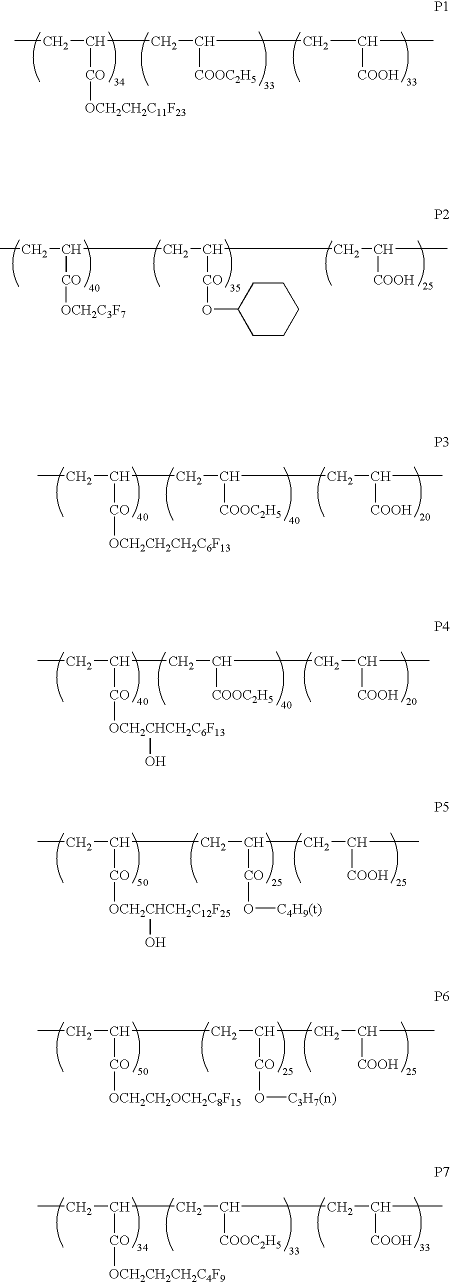

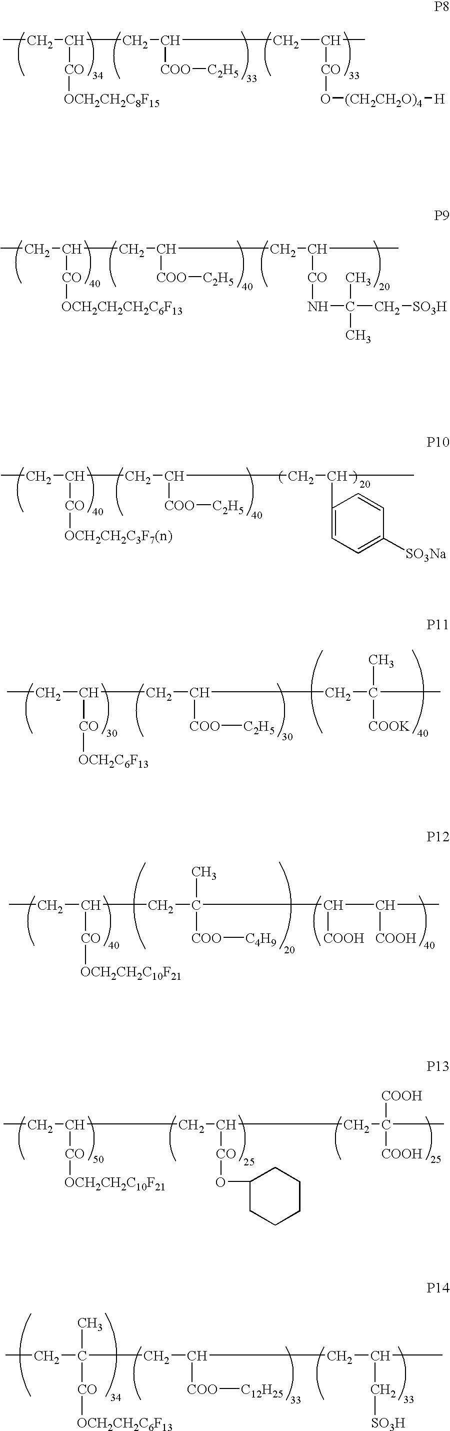

The content of the copolymer in the invention in the light sensitive layer is preferably from 0.01 to 10% by weight, and more preferably from 0.05% to 5% by weight. (Light sensitive layer, Image formation layer)

The light sensitive planographic printing plate material of the invention comprises a support and provided thereon, a light sensitive layer.

The light sensitive layer in the invention is a layer capable of forming an image by imagewise exposure. As the light sensitive layer, a positive or negative working light sensitive layer used in a conventional light sensitive planographic printing plate material can be used. As the light sensitive layer in the invention, a polymerizable light sensitive layer is especially effective.

As the light sensitive layer, there is a positive working light sensitive layer containing a compound capable of being decomposed by an acid or a negative working light sensitive layer containing a polymerizable composition.

The positive working light sensitive layer will be detailed below.

As the positive working light sensitive layer containing a compound capable of being decomposed by an acid, there is, for example, a light sensitive layer containing a photolytically acid generating agent capable of generating an acid on laser exposure, an acid decomposable compound, which is decomposed by the generated acid to increase solubility to a developer, and an infrared absorber, as disclosed in Japanese Patent O.P.I. Publication No. 9-171254.

As the photolytically acid generating agents, there are various conventional compounds and mixtures. For example, a salt of diazonium, phosphonium, sulfonium or iodonium ion with BF₄⁻, PF₆⁻, SbF₆²⁻SiF₆²⁻or ClO₄, an organic halogen containing compound, o-quinonediazide sulfonylchloride or a mixture of an organic metal and an organic halogen-containing compound is a compound capable of generating or releasing an acid on irradiation of an active light, and can be used as the photolytically acid generating agent in the invention. The organic halogen-containing compound, which is known as a photoinitiator capable of forming a free radical, is a compound capable of generating a hydrogen halide and can be used as the photolytically acid generating agent. The examples of the organic halogen-containing compound capable of forming a hydrogen halide include those disclosed in U.S. Pat. Nos. 3,515,552, 3,536,489 and 3,779,778 and West German Patent No. 2,243,621, and compounds generating an acid by photodegradation disclosed in West German Patent No. 2,610,842. As the photolytically acid generating agent, o-naphthoquinone diazide-4-sulfonylhalogenides disclosed in Japanese Patent O.P.I. Publication No. 50-30209 can be also used.

As the photolytically acid generating agent, an organic halogen-containing compound is preferred in view of sensitivity to infrared rays and storage stability. The organic halogen-containing compounds are preferably halogenated alkyl-containing triazines or halogenated alkyl-containing oxadiazoles, and especially preferably halogenated alkyl-containing s-triazines.

The content of the photolytically acid generating agent in the light sensitive layer is preferably 0.1 to 20% by weight, and more preferably 0.2 to 10% by weight based on the total weight of the solid components of the light sensitive layer, although the content broadly varies depending on its chemical properties, or kinds or physical properties of light sensitive layer used.

As the acid decomposable compounds, there are compounds having a C—O—C bond disclosed in Japanese Patent O.P.I. Publication Nos. 48-89003, 51-120714, 53-133429, 55-12995, 55-126236 and 56-17345, compounds having an Si—O—C bond disclosed in Japanese Patent O.P.I. Publication Nos. 60-37549 and 60-121446, another acid decomposable compound disclosed in Japanese Patent O.P.I. Publication Nos. 60-3625 and 60-10247, compounds having an Si—N bond disclosed in Japanese Patent O.P.I. Publication No. 62-222246, carbonic acid esters disclosed in Japanese Patent O.P.I. Publication No. 62-251743, orthocarbonic acid esters disclosed in Japanese Patent O.P.I. Publication No. 62-209451, orthotitanic acid esters disclosed in Japanese Patent O.P.I. Publication No. 62-280841, orthosilicic acid esters disclosed in Japanese Patent O.P.I. Publication No. 62-280842, acetals or ketals disclosed in Japanese Patent O.P.I. Publication No. 63-10153, and compounds having a C—S bond disclosed in Japanese Patent O.P.I. Publication No. 62-244038. Of these compounds, the compounds having a C—O—C bond, the compounds having an Si—O—C bond, orthocarbonic acid esters, the acetals or ketals as described above and silyl ethers are preferred.

The content of the acid decomposable compound in the light sensitive layer is preferably-5 to 70% by weight, and more preferably 10 to 50% by weight based on the total weight of the solid components of the light sensitive layer. The acid decomposable compounds may be used alone or as an admixture of two or more kinds thereof.

Examples of the infrared absorbing dye include a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include those disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination. Those described in Japanese Patent O.P.I. Publication Nos. 11-240270, 11-265062, 2000-309174, 2002-49147, 2001-162965, 2002-144750, and 2001-219667 can be preferably used.

The content of the infrared absorbing dye in the light sensitive layer is preferably from 0.5 to 10% by weight, and more preferably from 0.8 to 5% by weight.

[Light-to-heat Conversion Agents]

Besides the infrared absorbing dye above, the following light-to-heat conversion agents can be used in combination.

Preferred examples of the light-to-heat conversion agents include carbon, graphite, a metal and a metal oxide.

Furnace black and acetylene black is preferably used as the carbon. The graininess (d₅₀) thereof is preferably not more than 100 nm, and more preferably not more than 50 nm. The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions or materials which are electro-conductive or semi-conductive can be used. Examples of the former include black iron oxide and black complex metal oxides containing at least two metals. Examples of the latter include Sb-doped SnO₂ (ATO), Sn-added In₂0₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable.

These oxides are particles having a particle size of not more than 0.5 μm, preferably not more than 100 nm, and more preferably not more than 50 nm.

As these light-to-heat conversion agents, black iron oxide or black complex metal oxides containing at least two metals are more preferred. Examples of the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency as compared with another metal oxide.

The primary average particle size of these complex metal oxides is preferably from 0.001 to 1.0 μm, and more preferably from 0.01 to 0.5 μm. The primary average particle size of from 0.001 to 1.0 μm improves light heat conversion efficiency relative to the addition amount of the particles, and the primary average particle size of from 0.05 to 0.5 μm further improves light heat conversion efficiency relative to the addition amount of the particles.

The light heat conversion efficiency relative to the addition amount of the particles depends on a dispersity of the particles, and the well-dispersed particles have high light heat conversion efficiency.

Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles.

The content of the light-to-heat conversion material in the light sensitive layer is preferably from 0.5 to 15% by weight, and more preferably from 0.8 to 5% by weight.

It is preferred that the positive working light sensitive layer as described above contains a polymeric binder as described later. The content of the polymeric binder in the light sensitive layer is preferably from 15 to 70% by weight, and more preferably from 20 to 50% by weight.

As the positive working light sensitive layer, a light sensitive layer containing o-naphthoquinone is preferably used.

The light-to-heat conversion materials described above may be contained in the light sensitive layer or in a layer adjacent thereto.

In the invention, the thickness of the positive working light sensitive layer is preferably from 0.5 to 5.0 g/m², and more preferably from 1.0 to 3.0 g/m².

The negative working light sensitive layer will be detailed below.

As the negative working light sensitive layer, there is, for example, a light sensitive layer containing a polymerizable ethylenically unsaturated compound, a photopolymerization initiator, a polymeric binder, and preferably a sensitizing dye. As the sensitizing dye, a dye having absorption maximum in the wavelength regions of from 350 to 450 nm is preferably used.

(Polymerizable Ethylenically Unsaturated Compound)

The polymerizable ethylenically unsaturated compound (hereinafter referred to simply as ethylenically unsaturated compound) is a compound polymerizing on imagewise exposure.

Examples of the ethylenically unsaturated compound include conventional radically polymerizable monomers, and polyfunctional monomers and polyfunctional oligomers each having plural ethylenically unsaturated bond ordinarily used in UV-curable resins. The ethylenically unsaturated compound is not specifically limited, but preferred examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryloxyethyl acrylate, tetrahydrofurfuryloxyhexyl acrylate, or 1,3-dioxolanyl acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate, hydroxypivalylaldehyde modified dimethylolpropane triacrylate or EO-modified products thereof; and a methacrylate, itaconate, crotonate or maleate alternative of the above polyfunctional acrylate.

A prepolymer can be used as the ethylenically unsaturated compound described above. Examples of the prepolymer include compounds described later and prepolymers with a photopolymerization property obtained by incorporating an acryloyl or methacryloyl group into a prepolymer with an appropriate molecular weight. These prepolymers can be used singly or as an admixture of the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A.epichlorhydrin.(meth)acrylic acid or phenol novolak.epichlorhydrin.(meth)acrylic acid obtained by incorporating (meth)acrylic acid in an epoxy resin; an urethaneacrylate such as ethylene glycol.adipic acid.tolylenediisocyanate.2-hydroxyethylacrylate, polyethylene glycol.tolylenediisocyanate.2-hydroxyethylacrylate, hydroxyethylphthalyl methacrylate.xylenediisocyanate, 1,2-polybutadieneglycol.tolylenediisocyanate-2-hydroxyethylacrylate or trimethylolpropane.propylene glycol.tolylenediisocyanate.2-hydroxyethylacrylate, obtained by incorporating (meth)acrylic acid in an urethane resin; a silicone acrylate such as polysiloxane acrylate, or polysiloxane.diisocyanate.2-hydroxyethylacrylate; an alkyd modified acrylate obtained by incorporating a methacroyl group in an oil modified alkyd resin; and a spiran resin acrylate.

The light sensitive layer can contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

As the ethylenically unsaturated compound used in combination in the light sensitive layer, there is a phosphate compound having at least one (meth)acryloyl group. The phosphate compound is a compound having a (meth)acryloyl group in which at least one hydroxyl group of phosphoric acid is esterified, but is not limited as long as it has a(meth)acryloyl group.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV.EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

It is preferred in the invention that the light sensitive layer contains a tertiary amine monomer, an ethylenically unsaturated compound having a tertiary amino group in the molecule. The monomer is not specifically limited to the chemical structure, but is preferably a hydroxyl group-containing tertiary amine modified with glycidyl methacrylate, methacrylic acid chloride or acrylic acid chloride. Typically, a polymerizable compound is preferably used which is disclosed in Japanese Patent O.P.I. Publication Nos. 1-203413 and 1-197213.

In the invention, a reaction product of a polyhydric alcohol having a tertiary amino group in the molecule, a diisocyanate, and a compound having both a hydroxyl group and an addition polymerizable ethylenically double bond in the molecule is preferably used. A compound having a tertiary amino group and an amide bond in the molecule is especially preferred.

Examples of the polyhydric alcohol having a tertiary amino group in the molecule include triethanolamine, N-methyldiethanolamine, N-ethyldiethanolamine, N-ethyldiethanolamine, N-n-butyldiethanolamine, N-tert-butyldiethanolamine, N,N-di(hydroxyethyl)aniline, N,N, N′, N′-tetra-2-hydroxypropylethylenediamine, p-tolyldiethanolamine, N,N, N′, N′-tetra-2-hydroxyethylethylenediamine, N,N-bis(2-hydroxypropyl)aniline, allyldiethanolamine, -3-dimethylamino-1,2-propane diol, 3-diethylamino-1,2-propane diol, N,N-di(n-propylamino)-2,3-propane diol, N,N-di(iso-propylamino)-2,3-propane diol, and 3-(N-methyl-N-benzylamino)-1,2-propane diol, but the invention is not specifically limited thereto.

Examples of the diisocyanate include butane-1,4-diisocyanate, hexane-1,6-diisocyanate, 2-methylpentane-1,5-diisocyanate, octane-1,8-diisocyanate, 1,3-diisocyanatomethylcyclohexanone, 2,2,4-trimethylhexane-1,6-diisocyanate, isophorone diisocyanate, 1,2-phenylene diisocyanate, 1,3-phenylene diisocyanate, 1,4-phenylene diisocyanate, tolylene-2,4-diisocyanate, tolylene-2,5-diisocyanate, tolylene-2,6-diisocyanate, 1,3-di(isocyanatomethyl)benzene, and 1,3-bis(1-isocyanato-1-methylethyl)benzene, but the invention is not specifically limited thereto.

Examples of the compound having a hydroxyl group and an addition polymerizable ethylenically double bond in the molecule is not specifically limited, but 2-hydroxyethyl methacrylate, 2-hydroxyethyl acrylate, 4-hydroxybutyl acrylate, 2-hydroxypropylene-1,3-dimethacrylate, and 2-hydroxypropylene-1-methacrylate-3-acrylate are preferred.

The reaction product can be synthesized according to the same method as a conventional method in which a urethaneacrylate compound is ordinarily synthesized employing a diol, a diisocyanate and an acrylate having a hydroxyl group.

Examples of the reaction product of a polyhydric alcohol having a tertiary amino group in the molecule, a diisocyanate, and a compound having a hydroxyl group and an addition polymerizable ethylenically double bond in the molecule will be listed below.
M−1: A reaction product of triethanolamine (1 mole), hexane-1,6-diisocyanate (3 moles), and 2-hydroxyethyl methacrylate (3 moles)
M-2: A reaction product of triethanolamine (1 mole), isophorone diisocyanate (3 moles), and 2-hydroxyethyl methacrylate (3 moles)
M-3: A reaction product of N-n-butyldiethanolamine (1 mole), 1,3-bis(1-cyanato-l-methylethyl)benzene (2 moles), and 2-hydroxypropylene-1-methacrylate-3-acrylate (2 moles)
M-4: A reaction product of N-n-butyldiethanolamine (1 mole), 1,3-di(cyanatomethyl)benzene (2 moles), and 2-hydroxypropylene-1-methacrylate-3-acrylate (2 moles)
M-5: A reaction product of N-methydiethanolamine (1 mole), tolylene-2,4-diisocyanate (2 moles), and 2-hydroxypropylene-1,3-dimethacrylate (2 moles)

In addition to the above, acrylates or methacrylates disclosed in Japanese Patent O.P.I. Publication Nos. 2-105238 and 1-127404 can be used.

The ethylenically unsaturated compound content of the light sensitive layer is preferably from 30 to 70% by weight, and more preferably from 40 to 60% by weight.

(Photopolymerization Initiator)

The photopolymerization initiator in the invention is a compound which initiates polymerization of an ethylenically unsaturated compound on light exposure. As the photopolymerization initiator is used a biimidazole compound, an iron arene complex, a titanocene compound, a polyhalogenated compound or a monoalkyltriaryl borate compound. Among these, a biimidazole compound or an iron arene complex is preferred. A combined use of a polyhalogenated compound with the biimidazole compound or the iron arene complex is especially preferred.

(Biimidazole Compound)

The biimidazole compound is a derivative of biimidazole, and examples thereof include those disclosed in for example, Japanese Patent O.P.I. Publication No. 2003-295426. In the invention, a hexaarylbisimidazole (HABI, a dimer of a triarylimidazole) compound is preferred as the biimidazole compound. The synthetic method of the hexaarylbisimidazoles (HABI, dimmers of triarylimidazoles) is disclosed in DIELECTRIC 1470154, and use thereof in a photopolymerizable composition is disclosed in EP 24629, EP 107792, U.S. Pat. No. 4,410,621, EP 215453 and DE 321312.

Preferred examples of the biimidazole compound include 2,4,5,2′,4′,5′-hexaphenylbisimidazole, 2,2′-bis(2-chlorophenyl)-4,5,4′,5′-tetraphenylbisimidazole, 2,2′-bis(2-bromophenyl)-4,5,4′,5′-tetraphenylbisimidazole, 2,2′-bis(2,4-dichlorophenyl)-4,5,4′,5′-tetraphenylbisimidazole, 2,2′-bis(2-chlorophenyl)-4,5,4′,5′-tetrakis(3-methoxyphenyl)bisimidazole, 2,2′-bis(2-chlorophenyl)-4,5,4′,5′-tetrakis(3,4,5-trimethoxyphenyl)bisimidazole, 2,5,2′,5′-tetrakis(2-chlorophenyl)-4,4′-bis(3,4-dimethoxyphenyl)bisimidazole, 2,2′-bis(2,6-dichlorophenyl)-4,5,4′,5′-tetraphenylbisimidazole, 2,2′-bis(2-nitrophenyl)-4,5,4′,5′-tetraphenylbisimidazole, 2,2′-di-o-tolyl-4,5,4′,5′-tetraphenylbisimidazole, 2,2′-bis(2-ethoxyphenyl)-4,5,4′,5′-tetraphenylbisimidazole, and 2,2′-bis(2,6-difluorophenyl)-4,5,4′,5′-tetraphenylbisimidazole.

(Iron Arene Complex)

The iron arene complex used in the invention is a compound represented by formula (5) below. Formula (5)
(A-Fe—B)⁺X⁻
wherein A represents a substituted or unsubstituted cyclopentadienyl group or a substituted or unsubstituted cyclohexadienyl group; B represents a compound having an aromatic ring; and X⁻is an anion.

Examples of the compound having an aromatic ring include benzene, toluene, xylene, cumene, naphthalene, 1-methylnaphtalene, 2-methylnaphtalene, biphenyl, fluorene, anthracene and pyrene. Examples of X⁻include PF₆⁻, BF₄⁻, SbF₆⁻, AlF₄⁻, and CF₃SO₃⁻. The substituents of the substituted or unsubstituted cyclopentadienyl group or a substituted or unsubstituted cyclohexadienyl group include an alkyl group such as methyl, ethyl, etc., a cyano group, an acetyl group and a halogen atom.

Examples of the iron arene complex include:
Fe-1: (η6-benzene)(η5-cyclopentadienyl)iron (2) hexafluorophosphate;
Fe-2: (η6-toluene)(η5-cyclopentadienyl)iron (2) hexafluorophosphate;
Fe-3: (η6-cumene)(η5-cyclopentadienyl)iron (2) hexafluorophosphate;
Fe-4: (η6-benzene)(η5-cyclopentadienyl)iron (2) hexafluoroarsenate;
Fe-6: (η6-benzene)(η5-cyclopentadienyl)iron (2) tetrafluoroborate;
Fe-6: (η6-naphthalene)(η5-cyclopentadienyl)iron (2) hexafluorophosphate;
Fe-7: (η6-anthracene)(η5-cyclopentadienyl)iron (2) hexafluorophosphate;
Fe-8: (η6-pyrene)(η5-cyclopentadienyl)iron (2) hexafluorophosphate;
Fe-9: (η6-benzene)(η5-cyanocyclopentadienyl)iron (2) hexafluorophosphate;
Fe-10: (η6-toluene)(η5-acetylcyclopentadienyl)iron (2) hexafluorophosphate;
Fe-11: (η6-cumene)(η5-cyclopentadienyl)iron (2) tetrafluoroborate;
Fe-12: (η6-benzene)(η5-carboethoxycyclohexadienyl)iron (2) hexafluorophosphate;
Fe-13: (η6-benzene)(η5-1,3-dichlorocyclohexadienyl)iron (2) hexafluorophosphate;
Fe-14: (η6-cyanobenzene)(η5-cyclohexadienyl)iron (2) hexafluorophosphate;
Fe-15: (η6-acetophenone)(η5-cyclohexadienyl)iron (2) hexafluorophosphate;
Fe-16: (η6-methyl benzoate)(η5-cyclopentadienyl)iron (2) hexafluorophosphate;
Fe-17: (η6-benzene sulfonamide)(η5-cyclopentadienyl)iron (2) tetrafluoroborate;
Fe-18: (η6-benzamide)(η5-cyclopentadienyl)iron (2) hexafluorophosphate;
Fe-19: (η6-cyanobenzene)(η5-cyanocyclopentadienyl)iron (2) hexafluorophosphate;
Fe-20: (η6-chloronaphthalene)(η5-cyclopentadienyl)iron (2) hexafluorophosphate;
Fe-21: (η6-anthracene)(η5-cyanocyclopentadienyl)iron (2) hexafluorophosphate;
Fe-22: (η6-chlorobenzene)(η5-cyclopentadienyl)iron (2) hexafluorophosphate; and
Fe-23: (η6-chlorobenzene)(η5-cyclopentadienyl)iron (2) tetrafluoroborate.

These compounds can be synthesized according to a method described in Dokl. Akd. Nauk. SSSR 149 615 (1963).

The titanocene compounds are described in Japanese Patent O.P.I. Publication Nos. 63-41483 and 2-291. Preferred examples of the titanocene compounds include bis(cyclopentadienyl)-Ti-di-chloride, bis(cyclopentadienyl)-Ti-bis-phenyl, bis(cyclopentadienyl)-Ti-bis-2,3,4,5,6-pentaflurophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,6-difluorophenyl (IRUGACURE 784, produced by Ciba Speciality Chemicals Co.), bis(cyclopentadienyl)-bis(2,4,6-trifluoro-3-(pyry-1-yl)phenyl)titanium, and bis(cyclopentadienyl)-bis(2,4,6-trifluoro-3-(2-5-dimethylpyry-1-yl)phenyl)titanium.

It is preferred in the invention that the light sensitive layer further contains a polyhalogenated compound.

The polyhalogenated compound is a compound having a trihalomethyl group, a dihalomethyl group or a dihalomethylene group. In the invention, an oxadiazole compound having in the molecule the group described above as the substituent or a polyhalogenated compound represented by the following formula (6) is preferably used.
R¹—C (Y)₂—(C═O)—R² Formula (6)
wherein R¹ represents a hydrogen atom, a halogen atom, an alkyl group, an aryl group, an acyl group, an alkylsulfonyl group, an arylsulfonyl group, an iminosulfo group or a cyano group; R² represents a monovalent substituent, provided that R¹ and R² may combine with each other to form a ring; and Y represents a halogen atom.

The monovalent substituent represented by R² represents a substituted or unsubstituted alkyl group, a substituted or unsubstituted aryl group, a substituted or unsubstituted heterocyclic ring group, a substituted or unsubstituted alkoxy group, a substituted or unsubstituted aryloxy group, a substituted or unsubstituted amino group or a hydroxyl group.

A polyhalogenated compound represented by the following formula (7) is especially preferably used.
C(Y)₃—(C═O)—X—R³ Formula (7)
wherein R³ represents a monovalent substituent; X represents —O— or —NR⁴— in which R⁴ represents a hydrogen atom or an alkyl group, provided that when X represents —NR⁴—, R³ and R⁴ may combine with each other to form a ring; and Y represents a halogen atom.

The monovalent substituent represented by R³ represents a substituted or unsubstituted alkyl group, a substituted or unsubstituted aryl group, or a substituted or unsubstituted heterocyclic ring group.

Among these, a polyhalogenated compound having a polyhaloacetylamido group is preferably used.

An oxadiazole compound having a polyhalomethyl group as the substituent also is preferably used.

As the monoalkyltriaryl borate compound, there are those described in Japanese Patent O.P.I. Publication Nos. 62-150242 and 62-143044. Preferred examples of the monoalkyl-triaryl borate compounds include tetra-n-butyl ammonium n-butyltrinaphthalene-1-yl-borate, tetra-n-butylammonium n-butyltriphenylborate, tetra-n-butylammonium triphenyl-mono-t-butylborate, tetra-n-butylammonium n-butyl-tri-(4-tert-butylphenyl)borate, tetra-n-butylammonium n-hexyl-tri-(3-chloro-4-methylphenyl)borate, and tetra-n-butylammonium n-hexyl-tri-(3-fluorophenyl)borate.

In the invention, known photopolymerization initiators other than those described above can be used in combination.

The content of the photopolymerization initiator in the light-sensitive layer is preferably from 0.1 to 20% by weight, and more preferably from 0.1 to 10% by weight, based on the amount of the polymerizable ethylenically unsaturated compound contained in the light sensitive layer.

(Polymeric Binder)

Next, the polymeric binder will be explained.

As the polymeric binder in the invention can be used a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These resins can be used as an admixture of two or more thereof.

The alkali-soluble polymeric binder in the invention is preferably a vinyl copolymer obtained by copolymerization of an acryl monomer, and more preferably a copolymer containing, as the copolymerization component, (a) a carboxyl group-containing monomer unit and (b) an alkyl methacrylate or alkyl acrylate unit.

Examples of the carboxyl group-containing monomer include an α, β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The alkali-soluble polymeric binder in the invention can further contain, as another monomer unit, a monomer unit derived from the monomer described in the following items (1) through (14):

1) A monomer having an aromatic hydroxy group, for example, o-, (p- or m-) hydroxystyrene, or o-, (p- or m-) hydroxyphenylacrylate;

2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

3) A monomer having an aminosulfonyl group, for example, m- or p-aminosulfonylphenyl methacrylate, m- or p-aminosulfonylphenyl acrylate, N-(p-aminosulfonylphenyl) methacrylamide, or N-(p-aminosulfonylphenyl)acrylamide;

4) A monomer having a sulfonamido group, for example, N-(p-toluenesulfonyl)acrylamide, or N-(p-toluenesulfonyl)-methacrylamide;

5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

7) A vinyl ether, for example, ethyl vinyl ether, 2-chloroethyl vinyl ether, propyl vinyl ether, butyl vinyl ether, octyl vinyl ether, or phenyl vinyl ether;

8) A vinyl ester, for example, vinyl acetate, vinyl chroloacetate, vinyl butyrate, or vinyl benzoate;

9) A styrene, for example, styrene, methylstyrene, or chloromethystyrene;

10) A vinyl ketone, for example, methyl vinyl ketone, ethyl vinyl ketone, propyl vinyl ketone, or phenyl vinyl ketone;

11) An olefin, for example, ethylene, propylene, isobutylene, butadiene, or isoprene;

12) N-vinylpyrrolidone, N-vinylcarbazole, or N-vinylpyridine,

13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer.

The polymeric binder in the invention is preferably a vinyl polymer having in the side chain a carboxyl group and a polymerizable double bond. As the polymer binder is also preferred an unsaturated bond-containing copolymer which is obtained by reacting a carboxyl group contained in the above vinyl copolymer molecule with for example, a compound having a (meth)acryloyl group and an epoxy group.

Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-27196. Further, an unsaturated bond-containing copolymer which is obtained by reacting a hydroxyl group contained in the above vinyl copolymer molecule with for example, a compound having a (meth)acryloyl group and an isocyanate group. Examples of the compound having a (meth)acryloyl group and an isocyanate group in the molecule include vinyl isocyanate, (meth)acryl isocyanate, 2-(meth)acroyloxyethyl isocyanate, m- or p-isopropenyl-α,α′-dimethylbenzyl isocyanate, and (meth)acryl isocyanate, or 2-(meth)acroyloxyethyl isocyanate is preferred.

Reaction of a carboxyl group existing in the molecule of the vinyl copolymer with a compound having in the molecule a (meth)acryloyl group and an epoxy group can be carried out according to a well-known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an aliphatic epoxy group-containing unsaturated compound is incorporated into the vinyl copolymer. The reaction can be carried out in the presence of a catalyst or a polymerization inhibitor.

As the catalyst, there are amines or ammonium chlorides. Examples of the amines include triethylamine, tributylamine, dimethylaminoethanol, diethylaminoethanol, methylamine, ethylamine, n-propylamine, i-propylamine, 3-methoxypropylamine, butylamine, allylamine, hexylamine, 2-ethylhexylamine, and benzylamine. Examples of the ammonium chlorides include triethylbenzylammonium chloride. The amount used of the catalyst is ordinarily from 0.01 to 20.0% by weight based on the weight of an aliphatic epoxy group-containing unsaturated compound used. Examples of the polymerization inhibitor include hydroquinone, hydroquinone monometyl ether, 2,5-di-t-butylhydroquinone, 2,6-di-t-butylhydroquinone, 2-methylhydroquinone, and 2-t-butylhydroquinone. The amount used of the polymerization inhibitor is ordinarily from 0.01 to 5.0% by weight based on the weight of aliphatic epoxy group-containing unsaturated compound used. The reaction process is controlled by measurement of acid value of the reaction mixture and the reaction is terminated at the time when the intended acid value is attained.

Reaction of a hydroxyl group existing in the molecule of the vinyl copolymer with a compound having in the molecule a (meth)acryloyl group and an isocyanate group can be carried out according to a known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an isocyanate group-containing unsaturated compound is incorporated into the vinyl copolymer. The reaction can be carried out in the presence of a catalyst or a polymerization inhibitor. As the catalyst, tin compounds or amines are preferably used. Examples of thereof include dibutyltin laurate, and triethylamine. The amount used of the catalyst is preferably from 0.01 to 20.0% by weight based on the weight of a double bond-containing compound used. Examples of the polymerization inhibitor include hydroquinone, hydroquinone monometyl ether, 2,5-di-t-butylhydroquinone, 2,6-di-t-butylhydroquinone, 2-methylhydroquinone, and 2-t-butylhydroquinone. The amount used of the polymerization inhibitor is ordinarily from 0.01 to 5.0% by weight based on the weight of isocyanate group-containing unsaturated compound used. The reaction process is controlled by measurement of infrared absorption spectra (IR) of the reaction mixture and the reaction is terminated at the time when the isocyanate absorption disappears.

The content of the vinyl polymer having in the side chain a carboxyl group and a polymerizable double bond is preferably from 50 to 100% by weight, and more preferably 100% by weight, based on the total weight of the polymer binder used.

The alkali-soluble polymeric binder content of the light sensitive layer is preferably from 10 to 90% by weight, more preferably from 15 to 70% by weight, and still more preferably from 20 to 50% by weight, in view of sensitivity.

(Sensitizing Dye)

In the invention, a dye having absorption maximum in the wavelength regions of from 300 to 1200 nm can be used as the sensitizing dye. In the invention, a dye having absorption maximum in the wavelength regions of from 350 to 450 nm is preferably used in providing the advantageous effects of the invention.

Examples of the dyes include cyanine, merocyanine, porphyrin, a spiro compound, ferrocene, fluorene, fulgide, imidazole, perylene, phenazine, phenothiazine, acridine, an azo compound, diphenylmethane, triphenylmethane, triphenylamine, cumarin derivatives, ketocumarin, quinacridone, indigo, styryl, pyrylium compounds, pyrromethene compounds, pyrazolotriazole compounds, benzothiazole compounds, barbituric acid derivatives, thiobarbituric acid derivatives, and ketoalcohol borate complexes.

A coumarin dye represented by the following formula (8) is especially preferred.

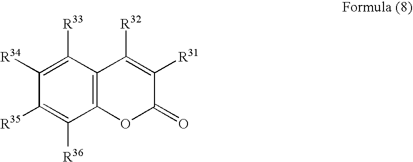

In formula (2), R⁻, R³², R³³, R³⁴, R³⁵ and R³⁶ independently represent a hydrogen atom or a substituent. Examples of the substituent include an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or a allyl group), an alkinyl group (for example, a propargyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxy group (for example, a methoxy group, an ethoxy group, a propoxy group, a pentyloxy group, a hexyloxy group, an octyloxy group, or a dodecyloxy group), a cycloalkoxy group (for example, a cyclopentyloxy group, or a cyclohexyloxy group), an aryloxy group (for example, a phenoxy group or a naphthyloxy group), an alkylthio group (for example, a methylthio group, an ethylthio group, a propylthio group, a pentylthio group, a hexylthio group, an octylthio group, or a dodecylthio group), a cycloalkylthio group (for example, a cyclopentylthio group or a cyclohexylthio group), an arylthio group (for example, a phenylthio group, or a naphthylthio group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), an amido group (for example, a methylcarbonylamino group, an ethylcarbonylamino group, a dimethylcarbonylamino group, a propylcarbonylamino group, a pentylcarbonylamino group, a cyclohexylcarbonylamino group, 2-ethylhexylcarbonylamino group, an octylcarbonylamino group, a a dodecycarbonylamino group, a phenylcarbonylamino group, a naphthylcarbonylamino group, or a pyridylcarbonyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a ureido group (for example, a methylureido group, an ethylureido group, a pentylureido. group, a cyclohexylureido group, an octylureido group, a dodecylureido group, a phenylureido group, a naphthylureido group, or a 2-pyridylureido group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), an amino group (for example, an amino group, an ethylamino group, a dimethylamino group, a butylaminocarbonyl group, a cyclopentylamino group, a 2-ethylhexylamino group, a dodecyamino group, an anilino group, a naphthylamino group, or a 2-pyridylamino group), a halogen atom (for example, fluorine, chlorine, or bromine), a cyano group, a nitro group, and a hydroxyl group. Any adjacent two of R⁻, R³², R³³, R³⁴, R³⁵ and R³⁶ may combine with each other to form a ring. R⁻, R³², R³³, R³⁴, R³⁵ and R³⁶ may be substituted or unsubstituted and the substituents of the substituted R⁻, R³², R³³, R³⁴, R³⁵ and R³⁶ include the same as those denoted above.

Coumarin dyes are preferred in which in formula (8), R³⁵ is an amino group or a substituted amino group such as an alkylamino group, a dialkylamino group, an arylamino group, a diarylamino group, or an alkylarylamino group. The coumarin compounds are preferably used in which the alkyl substituent of the substituted amino group in R³⁵ combines with R³⁴ or R³⁶ to form a ring.

Coumarin dyes are more preferred in which in addition to the above, at least one of R31 and R32 is an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or an allyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), a halogen atom (for example, fluorine, chlorine, or bromine), a cyano group, a nitro group or a halogenated alkyl group (for example, a trifluoromethyl group, a tribromomethyl group, or a trichloromethyl group).

Preferred examples will be listed below, but the invention is not limited thereto.

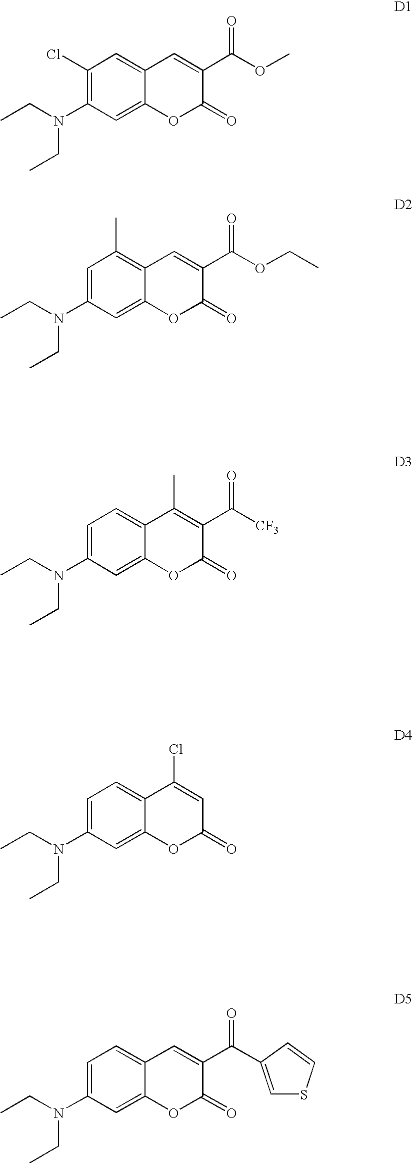

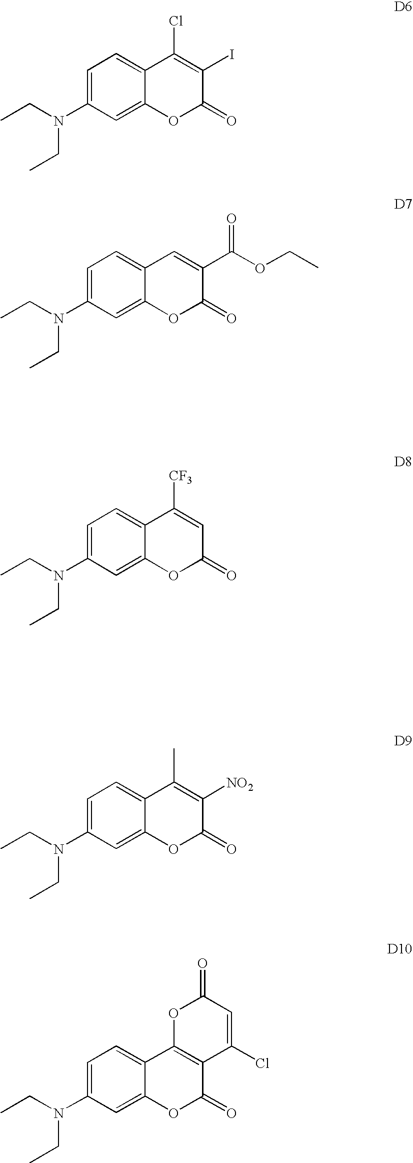

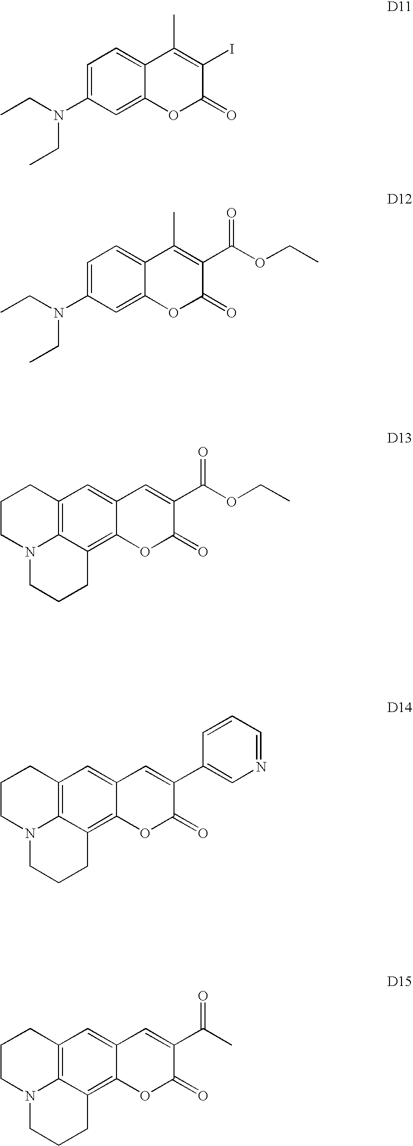

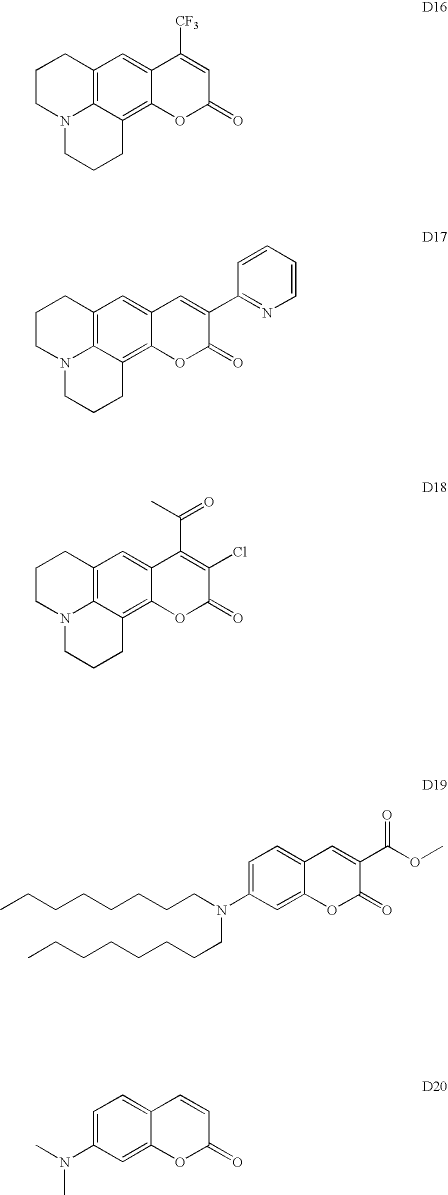

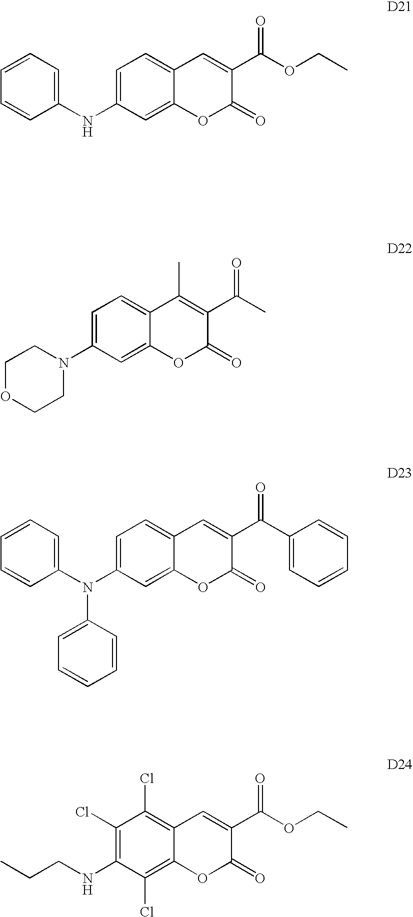

Besides the examples described above, there can be used coumarin derivatives B-1 through B-22 disclosed in Japanese Patent O.P.I. Publication No. 8-129258, coumarin derivatives D-1 through D-32 disclosed in Japanese Patent O.P.I. Publication No. 2003-12901, coumarin derivatives 1 through 21 disclosed in Japanese Patent O.P.I. Publication No. 2002-363206, coumarin derivatives 1 through 40 disclosed in Japanese Patent O.P.I. Publication No. 2002-363207, coumarin derivatives 1 through 34 disclosed in Japanese Patent O.P.I. Publication No. 2002-363208, or coumarin derivatives 1 through 56 disclosed in Japanese Patent O.P.I. Publication No. 2002-363209.

The sensitizing dye content of the light sensitive layer is preferably from 0.1 to 20% by weight, and more preferably from 0.1 to 10% by weight.

In the invention, the thickness of the negative working light sensitive layer is preferably from 0.5 to 5.0 g/m², and more preferably from 1.0 to 3.0 g/m².

Various additives which can be contained in the light sensitive layer described above, a support, a protective layer, a coating method of a light sensitive layer coating liquid on the support and a manufacturing method of a light sensitive planographic printing plate material will be explained below.

(Various Additives)

The light sensitive layer in the invention is preferably added with a polymerization inhibitor, in order to prevent undesired polymerization of the ethylenically unsaturated compound during the manufacture or after storage of light sensitive planographic printing plate material. Examples of the polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and 2-t-butyl-6-(3-t-butyl-6-hydroxy-5-mrthylbenzyl)-4-methylphenyl acrylate.

The polymerization inhibitor content is preferably 0.01 to 5% by weight based on the total solid content of the light sensitive layer. Further, in order to prevent undesired polymerization induced by oxygen, behenic acid or a higher fatty acid derivative such as behenic amide may be added to the layer. After the light sensitive layer is coated layer, the coated layer may be dried so that the higher fatty acid derivative is localized at the vicinity of the surface of the light sensitive, layer. The content of the higher fatty acid derivative is preferably 0.5 to 10% by weight, based on the total solid content of the light sensitive layer.

A colorant can be also used. As the colorant can be used known materials including commercially available materials. Examples of the colorant include those described in revised edition “Ganryo Binran”, edited by Nippon Ganryo Gijutu Kyoukai (publishe by Seibunndou Sinkosha), or “Color Index Binran”. Pigment is preferred.

Kinds of the pigment include black pigment, yellow pigment, red pigment, brown pigment, violet pigment, blue pigment, green pigment, fluorescent pigment, and metal powder pigment. Examples of the pigment include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these pigment, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content is preferably 0.1 to 10% by weight, and more preferably 0.2 to 5% by weight, based on the total solid content of the photopolymerizable light sensitive layer composition.

A purple pigment or a blue pigment is preferably utilized in view of absorption of light with the aforesaid photosensitive wavelength region and image visibility after development. Such pigments include, for example, Cobalt Blue, cerulean blue, Alkali Blue, Phonatone Blue 6G, Victoria Blue Lake, metal-free Phthalocyanine Blue, Phthalocyanine Fast Sky Blue, Indathrene Blue, indigo, Dioxane Violet, Isoviolanthrone Violet, Indanthrone Blue and Indanthrone BC. Among them, more preferable are Phthalocyanine Blue and Dioxane Violet.

The light sensitive layer can contain surfactants as a coating improving agent as long as the performance of the invention is not jeopardized. Among these surfactants, a fluorine-contained surfactant is preferred.

Further, in order to improve physical properties of the cured light sensitive layer, the layer can contain an inorganic filler or a plasticizer such as dioctyl phthalate, dimethyl phthalate or tricresyl phosphate. The content of such a material is preferably not more than 10% by weight, based on the total solid content of the light sensitive layer.

The light sensitive planographic printing plate material of the invention is manufactured by preparing a light sensitive layer coating liquid containing the above-described components and then coating on a support the light sensitive layer coating liquid to form a light sensitive layer on the support.

(Coating)

The solvents used in the preparation of the light sensitive layer coating liquid include an alcohol such as sec-butanol, isobutanol, n-hexanol, or benzyl alcohol; a polyhydric alcohol such as diethylene glycol, triethylene glycol, tetraethylehe glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

The light sensitive layer coating liquid is coated on the support according to a conventional method, and dried to obtain a light sensitive planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method. The drying temperature of the coated light sensitive layer is preferably from 60 to 160° C., more preferably from 80 to 140° C., and still more preferably from 90 to 120° C.

(Oxygen-shielding Layer)

When the light sensitive layer in the invention is photopolymerizable, an oxygen-shielding layer is preferably provided on the light sensitive layer. It is preferred that the oxygen-shielding layer is highly soluble in a developer

(Generally an Alkaline Solution).

Materials constituting the oxygen-shielding layer are preferably a hydrophilic polymeric compound selected from polyvinyl alcohol, polysaccharide, polyvinyl pyrrolidone, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide. These binders may be used alone or in combination. These materials, polyvinyl alcohol is more preferred, and polyvinyl alcohol having a degree of saponification of from 90 to 100% is most preferred.

Examples of the polyvinyl alcohol include Gosenol AL-06, and NL-05, each manufactured by Nippon Gosei Kagaku Co. Ltd.; Kuraray Poval PVA 706, PVACST, and PVA 105, each manufactured by Kuraray Co., Ltd.; Moviol 30-92, Moviol 3-96, Moviol 4-98, and Moviol 4-99, each manufactured by Cralliant Co., Ltd.; Erkol 30/92, Erkol 25/100, Erkol 28/70, Erkol 4/98, and Erkol 5/99, each manufactured by Backerchem Co., Ltd.; Elvanol 70-06 and Elvanol 71-30, each manufactured by Dupont Co., Ltd; and Celvol 418, Celvol 425, Celvol 103, Celvol 125, each manufactured by Celanese Co., Ltd.

Of these polyvinyl alcohols, those having a degree of saponification of from 90 to 98% are preferred, and those having a degree of saponification of from 90 to 96% are more preferred.

As a material constituting the oxygen-shielding layer, vinyl pyrrolidone copolymer is preferably used, and vinyl pyrrolidone copolymer having not less than 40 mol % of a vinyl pyrrolidone unit and having a weight average molecular weight of from 10,000 to 500,000 is more preferably used.

Vinyl pyrrolidone copolymer can be prepared, for example, by copolymerization of N-vinyl-2-pyrrolidone and a comonomer through a conventional radical polymerization process. As the comonomer, those polymerizable ethylenically unsaturated compounds as described above can be used. Vinyl acetate is especially preferred as the comonomer.

The vinyl pyrrolidone unit content in the vinyl pyrrolidone copolymer is preferably not less than 40 mol %, and more preferably from 40 to 80 mol %.

Examples of the vinyl pyrrolidone copolymer include Rubiscol VA37E, 371, 551, 64P, 64W, 73E, and 73W, each manufactured by BASF Japan Co., Ltd. The oxygen-shielding layer can further contain a surfactant or a matting agent.

As the surfactant, an anionic surfactant, a nonionic surfactant, a cationic surfactant or an amphoteric surfactant can be used. Acetylene surfactants are preferably used.

As the matting agent, inorganic or organic particles with an average particle size of from 0.01 to 10 μm can be used.

A coating liquid for the oxygen-shielding layer is obtained by dissolving the materials described above in a solvent. The coating liquid is coated on the light sensitive layer and dried to form an oxygen-shielding layer. The dry thickness of the protective layer is preferably from 0.1 to 5.0 pm, and more preferably from 0.5 to 3.0 μm.

(Oxygen-shielding Layer Coating Liquid) The oxygen-shielding layer coating liquid coating liquid is obtained by dissolving the materials described above in a solvent comprised mainly of water.

Alcohols or polyhydric alcohols are used as solvents other than water.

In the invention, the solvent comprised mainly of water is a solvent containing water in an amount of not less than 50% by weight. In the invention, the solvent is a solvent containing water in an amount of preferably not less than 75% by weight, and more preferably not less than 95% by weight.

The oxygen-shielding layer coating liquid is coated on the negative working light sensitive layer as described above and dried to form an oxygen-shielding layer.

When the oxygen-shielding layer coating liquid is coated on the light sensitive layer and dried, the drying temperature is preferably lower than a glass transition temperature (Tg) of the binder contained in the light sensitive layer. The drying temperature of the oxygen-shielding layer is preferably not less than 20° C. lower than Tg of the binder, and more preferably not less than 40° C. lower than Tg of the binder layer. The drying temperature of the oxygen-shielding layer is preferably at most 60° C. lower than Tg of the binder.

As coating methods of the oxygen-shielding layer coating liquid, there are conventional ones such as an air doctor coating method, a blade coating method, a wire bar coating method, a knife coating method, a dip coating method, a reverse roll coating method, a gravure coating method, a cast coating method, a curtain coating method and an extrusion coating method.

(Support)

The support used in the invention is a plate or a sheet capable of carrying the light sensitive layer and preferably has a hydrophilic surface on the side on which the light sensitive layer is to be provided.

As the supports used in the invention, a plate of a metal such as aluminum, stainless steel, chromium or nickel, or a plastic film such as a polyester film, a polyethylene film or a polypropylene film, which is deposited or laminated with the above-described metal can be used. Further, a polyester film, a polyvinyl chloride film or a nylon film whose surface is subjected to hydrophilization treatment can be used. Among the above, the aluminum plate is preferably used, and may be a pure aluminum plate or an aluminum alloy plate.

As the aluminum alloy, there can be used various ones including an alloy of aluminum and a metal such as silicon, copper, manganese, magnesium, chromium, zinc, lead, bismuth, nickel, titanium, sodium or iron. In the aluminum plate for the support, the surface is roughened for water retention.

It is preferable that the aluminum plate is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support. The surface roughening methods include a mechanical surface roughening method and an electrolytic surface roughening method electrolytically etching the support surface.

Though there is no restriction for the mechanical surface roughening method, a brushing roughening method and a honing roughening method are preferable.

Though there is no restriction for the electrolytic surface roughening method, a method, in which the support is electrolytically surface roughened in an acidic electrolytic solution, is preferred.

After the support has been electrolytically surface roughened, it is preferably dipped in an acid or an aqueous alkali solution in order to remove aluminum dust, etc. produced in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the support surface is preferably 0.5 to 5 g/m². After the support has been dipped in the aqueous alkali solution, it is-preferable for the support to be dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the invention, and known methods can be used. The anodizing treatment forms an anodization film on the surface of the support.

The support which has been subjected to anodizing treatment is optionally subjected to sealing treatment. For the sealing treatment, it is possible to use known methods using hot water, boiling water, steam, a sodium silicate solution, an aqueous dichromate solution,; a nitrite solution and an ammonium acetate solution.

After the above treatment, the support is suitably undercoated with a water soluble resin such as polyvinyl phosphonic acid, a polymer or copolymer having a sulfonic acid in the side chain, or polyacrylic acid; a water soluble metal salt such as zinc borate; a yellow dye; an amine salt; and so on, for hydrophilization treatment. The sol-gel treatment support disclosed in Japanese Patent O.P.I. Publication No. 5-304358, which has a functional group capable of causing addition reaction by radicals as a covalent bond, is suitably used.

In the invention, the light sensitive layer coating liquid is coated on a support according to a conventional coating method, and dried to obtain a light sensitive layer on the support.

Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

A drying temperature of the coated light sensitive layer is preferably from 60 to 160° C., more preferably from 80 to 140 OC, and still more preferably from 90 to 120° C.

### EXAMPLES

Next, the present invention will be explained employing the following examples, but is not limited thereto. In the examples, “parts” is parts by weight, unless otherwise specified.

(Preparation of Support 1) A 0.24 mm thick aluminum plate (material 1050, quality

H16) with a width of 1003 mm and a length of 800 mm was degreased at 60° C. for one minute in a 5% sodium hydroxide solution, electrolytically etched at 25° C. for 30 seconds at a current density of 60 A/dm² in an aqueous 0.6 mol/liter hydrochloric acid solution, then desmut at 60° C. for 10 seconds in a 5% sodium hydroxide solution, and then anodized at 20° C. for one minute at a current density of 3 A/dm² in a 20% sulfuric acid solution. The resulting aluminum plate was subjected to sealing treatment immersed in 30° C. hot water for 20 seconds. Thus, support 1 was obtained.

(Preparation of Light Sensitive Planographic Printing Plate Material)

The following light sensitive layer coating liquid was coated on the support 1 obtained above with an extrusion coater, dried at 60° C. for 20 seconds, and further dried at 100° C. for 40 seconds to obtain a light sensitive layer with a dry thickness of 2.0 g/m². Thus, light sensitive planographic printing plate material samples 1 through 6 were obtained.

(Light sensitive layer coating liquid composition)

| | |
|---|---|
| Binder 1 (described later) | 20 parts |
| Novolak resin | 40 parts |
| (polycondensate of phenol and mixed cresol consisting of | |
| m-cresol and p-cresol (m-cresol/p-cresol = 6/4 by weight) | |
| with formaldehyde; phenol/mixed cresol = 6/4 by weight) | |
| Acid decomposable compound A (described later) | 20 parts |
| Photolytically acid generating compound | 5 parts |
| Infrared absorbing dye IR-1 (described later) | 2 parts |
| Copolymer having units | Amount |
| represented by formulae (1), (2) and (3) or surfactants | as shown |
| (each being shown in Table 1) | in Table 1 |
| Propylene glycol monomethylether | 1000 parts |

(Synthesis of Acid Decomposable Compound A)

A mixture of 0.5 mol of 1,1-dimethoxycyclohexane, 1.0 mol of phenylcellosolve, and 80 mg of p-toluene sulfonic acid was reacted at 100° C. for 1 hour with stirring, and then gradually heated to 150° C. and further reacted at 150° C. for 4 hours, while methanol produced during reaction was removed.

The reaction mixture solution was cooled, added with 500 ml of tetrahydrofuran and 2.5 g of anhydrous potassium carbonate, stirred, and filtered to obtain a filtrate. The solvent of the filtrate was removed by evaporation under reduced pressure. Thereafter, residual low boiling point components of the filtrate were further removed under high vacuum pressure to obtain viscous oily substance, acid decomposable compound A (having the following chemical structure). 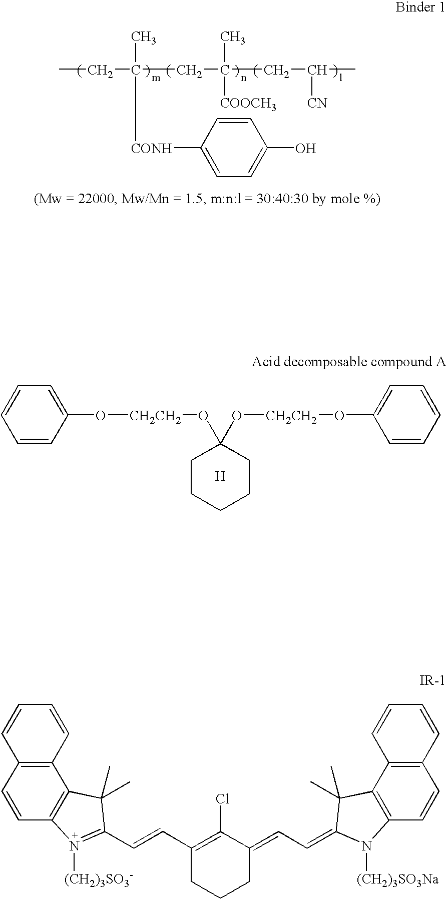
(Image Formation)
Exposure Conditions
Setter used: Trendsetter 400 Quantum (manufactured by Creo Co., Ltd.)

Exposure was carried out at a resolution of 2400 dpi (dpi represents the dot numbers per 2.54 cm), at an output power of 9.3 W and at a drum rotational frequency of 185 rpm.

(Development)

Developing machine used: InterPlater 85HD (manufactured by
Glunz & Jensen Co., Ltd.)
Developer:

| | | |
|---|---|---|
| Potassium silicate No. A | 100.0 | parts |
| Potassium hydroxide | 24.5 | parts |
| Caprylic acid | 0.2 | parts |
| Maleic acid | 2.0 | parts |
| EDTA (Ethylenediaminetetraacetic acid) | 0.3 | parts |
| Water | 1840 | parts |
| Developing temperature: 25 ± 1° C. | | |
| Developing time: 20 ± 1 seconds | | |
| Finisher used: GW-3 manufactured by Mitsubishi | | |
| Kagaku Co., Ltd. | | |

<Sensitivity 1>

Planographic printing plate material samples exposed at various exposure energy levels were developed to remove the light sensitive layer at exposed portions completely. The minimum energy level of the exposure energy levels was defined as sensitivity 1 and was represented in terms of mJ/cm².

<Dot Reproduction>Small dot reproduction and large dot reproduction were observed on the developed printing plate material samples. Dot images with a screen line number of 200 at highlight portions were observed at a dot area interval of 1%, and the minimum dot area (%) where small dot images were reproduced was evaluated as a measure of small dot reproduction. Dot images with a screen line number of 200 at shadow portions were observed at a dot area interval of 1%, and the~maximum dot area (%) where large dot images were reproduced was evaluated as a measure of large dot reproduction.

<Coatability>

Coatability was evaluated according to the following criteria:
A: No Marangoni was observed, the number of coating faults with a size of not more than 100 pm was less than 20, and no defects were observed.
B: Marangoni was observed, and the number of coating faults with a size of not more than 100 pm was from 20 to 100, but no major defects were observed.
C: Marked Marangoni was observed, the number of coating faults with a size of not more than 100 pm was more than 100, and major defects were observed.
   <<Interleaf Separability>>

One hundred samples were stacked, wherein an interleaf, in which PE film was laminated onto paper sheet, was inserted between the samples so that the PE film faces the light sensitive layer of the samples. Then, the samples was subjected to automatic interleaf separating test at 25° C. and 25% RH, employing Lotem 400 Quantum, and transportability of the samples was evaluated as a measure of interleaf separability. Interleaf separability was evaluated according to the following criteria:
A: No transporting failure occurred.
B: Transporting failure occurred.
   <<Sludge>>

Five hundred square meters of each sample were processed employing the developing machine described above, and after processing, sludge produced in the developing tank and sludge adhered on the developed sample were observed.

<Anti-sludge Contamination Properties>

(Ant-sludge Contamination Property 1)

The sludge produced was evaluated as a measure of ant-sludge contamination property 1 according to the following criteria:
A: The sludge was not adhered to the developed sample, which was not problematic.
B: The sludge was adhered to the developed sample in the developing tank, but removed in a washing section from the sample, which was not substantially problematic.
C: The sludge was adhered to the developed sample, causing contaminations at non-image portions.
   (Ant-sludge Contamination Property 2)

After Each sample was processed in the same manner as above, 100 ml of the developer was placed in a tightly sealed vessel and stored at 55° C. and 20% RH for 7 days. The resulting developer was filtered off to obtain a residue. The residue was dried at 70° C. for one day. The amount of the dried residue was represented in terms of g/liter and evaluated as a measure of ant-sludge contamination property 2.

The results are shown in Table 1.

As is appaent from Table 1, the light sensitive planographic printing plate materials of the invention provide good coatability, high sensitivity, high dot reproduction, excellent interleaf separability, and excellent anti-sludge contamination properties to sludge.

TABLE 1

| | Copolymer in | | | | | | | | | |
|---|---|---|---|---|---|---|---|---|---|---|
| | the invention | | | | | | | | | |
| | or surfactant | | | | | | | | | |
| Printing | used | | | | | | | | | |
| plate | | Amount | | | | | | | | |
| material | | (parts | | | | | | | | |
| sample | | by | Performances | | | | | | | Re- |
| No. | Kind | weight) | a) | b) | c) | d) | e) | f) | g) | marks |
| 1 | None | None | C | 150 | 7 | 90 | B | C | 3.5 | Comp. |
| 2 | F142D | 1 | B | 100 | 5 | 90 | B | C | 3 | Comp. |
| 3 | F178K | 1 | A | 90 | 5 | 95 | B | B | 3 | Comp. |
| 4 | P1 | 1 | A | 90 | 3 | 95 | A | A | 1 | Inv. |
| 5 | P4 | 1 | A | 85 | 3 | 95 | A | A | 0.6 | Inv. |
| 6 | P7 | 1 | A | 85 | 3 | 95 | A | A | 0.5 | Inv. |

Comp.: Comparative;
Inv: Inventive
a) Coatability;
b) Sensitivity 1 (mJ/cm²);
c) Small dot reproduction (%);
d) Large dot reproduction (%);
e) Interleaf separability;
f) Ant-contamination property 1;
g) Ant-contamination property 2 (g/liter)
F142D: Nonionic surfactant, perfluoroalkylethylene oxide (EO) adduct (EO = 10), produced by Dainippon Ink Kagaku Kogyo Co., Ltd.
F178K: Nonionic surfactant, perfluoroalkyl oligomer, produced by Dainippon Ink Kagaku Kogyo Co., Ltd.

(Preparation of Support 2)

The following compositions were mixed in a homogenizer for 15 minutes to prepare a hydrophilic subbing layer coating liquid and a hydrophilic layer coating liquid. The hydrophilic subbing layer coating liquid was coated on a 175 μm thick PET film subjected to hydrophilization treatment through a wire bar, and dried at 100° C. for 1 minute to form a hydrophilic subbing layer with a dry coating amount of 3 g/m². Successively, the hydrophilic layer coating liquid was coated on the resulting hydrophilic subbing layer through a wire bar, and dried at 100° C. for 1 minute to form a hydrophilic layer with a dry coating amount of 1 g/m². Thus, support 2 was obtained.

<Hydrophilic subbing layer coating liquid>

| | |
|---|---|
| Snowtex XS (solid content of 20% by weight, | 90 parts |
| colloidal silica with an average particle size of 4-6 nm, | |
| produced by Nissan Kagaku Co., Ltd.) | |
| Snowtex ZL (solid content of 40% by weight, | 2.5 parts |
| colloidal silica with an average particle size of 70-100 nm, | |
| produced by Nissan Kagaku Co., Ltd.) | |
| Silton JC 40 (aluminosilicate particles | 5 parts |
| having an average particle size of 4 μm, | |
| produced by Mizusawa Kagaku Co., Ltd.) | |
| Mineral Colloid MO (Montmorillonite, | 2 parts |
| available from WILBUR-ELLIS CO., LTD.) | |
| FZ2161 (silicon-containing surfactant, | 0.5 parts |
| produced by Nippon Unicar Co., Ltd.) | |
| <Hydrophilic layer coating liquid> | |
| Snowtex XS (solid content of 20% by weight, | 80 parts |
| colloidal silica with an average particle size of 4-6 nm, | |
| produced by Nissan Kagaku Co., Ltd.) | |
| Snowtex PSM (solid content of 20% by weight, | 12.5 parts |
| colloidal silica with an average particle size of 80-150 nm, | |
| produced by Nissan Kagaku Co., Ltd.) | |
| Silton JC 40 (aluminosilicate particles | 5 parts |
| having an average particle size of 4 μm, | |
| produced by Mizusawa Kagaku Co., Ltd.) | |
| Mineral Colloid MO (Montmorillonite, | 2 parts |
| available from WILBUR-ELLIS CO., LTD.) | |
| FZ2161 (silicon-containing surfactant, | 0.5 parts |
| produced by Nippon Unicar Co., Ltd.) | |

(Preparation of Support 3)

A 0.30 mm thick aluminum plate (material 1050, refining H16) was degreased at 65° C. for one minute in a 5% sodium hydroxide solution, and washed with water.

The degrease aluminum plate was immersed at 25° C. for one minute in a 10% sulfuric acid solution to neutralize, and then washed with water. The resulting aluminum plate was electrolytically etched using an alternating current at 25° C. for 20 seconds at a current density of 50 A/dm² and at a frequency of 50 Hz in an aqueous 11 g/liter hydrochloric acid solution, washed with water, desmutted at 50° C. for 10 seconds in a 1% sodium hydroxide solution, washed with water, neutralized at 50° C. for 30 seconds in a 30% sulfuric acid solution, and washed with water. The desmutted aluminum plate was anodized at 25° C. for 40 seconds at a current density of 5 A/dm² and at a voltage of 15 V in a 20% sulfuric acid solution, and washed with water.

The resulting anodized aluminum plate was immersed in a 0.44% polyvinyl phosphonic acid aqueous solution at 75° C. for 30 seconds, washed with pure water, and dried blowing cool air. Thus, support 3 was obtained. The center line average surface roughness (Ra) of the support 3 was 0.65 μm.

(Synthesis of Polymeric Binder A)

Methyl methacrylate of 58.0 parts, 35 parts of methacrylic acid, 6.0 parts of ethyl methacrylate, 100 parts of ethanol, and 1.23 parts of α, α′-azobisisobutylonitrile were placed in a three neck flask under nitrogen atmosphere. The resulting mixture was reacted under nitrogen atmosphere for 6 hours at 80° C. in an oil bath. After that, the reaction mixture was added with 1 part of triethylbenzylammonium chloride and 28 parts of glycidyl methacrylate, and reacted at 25° C. for 3 hours. Thus, Polymeric binder A was obtained. Polymeric binder A had a weight average molecular weight of 70,000, measured according to GPC, and an acid value of 95.

(Preparation of Light Sensitive Planographic Printing Plate material sample)

The following photopolymerizable light sensitive layer coating solution was coated on each of the supports 2 and 3 obtained above using a wire bar, and dried at 100° C. for 1.5 minutes to give a light sensitive layer with a dry thickness of 1.7 g/m². After that, the following protective layer coating solution was coated on the light sensitive layer using an applicator, and dried at 75° C. for 1.5 minutes to give a protective layer with a dry thickness of 1.7 g/m². Thus, planographic printing plate material samples, having a protective layer provided on a light sensitive layer, were obtained.

| | | |
|---|---|---|
| <<Photopolymerizable light sensitive layer coating solution>> | | |
| Polymer binder A | 45.0 | parts |
| Sensitizing dye A (described later) | 4.0 | parts |
| Iron-arene compound IRGACURE 261 | 3.2 | parts |
| (produced by Ciba Specialty Chemicals Co.) | | |
| Triazine Compound TAZ-107 | 2.5 | parts |
| (produced by Midori Kagaku Co., Ltd.) | | |
| Polymerizable ethylenically unsaturated | 30.0 | parts |
| monomer (Compound A described later) | | |
| Polyethylene glycol #200 dimethacrylate | 15.0 | parts |
| (NK ESTER 4G, produced by Shinnakamura Kagaku Kogyol Co., | | |
| Ltd.) | | |
| Phthalocyanine pigment | 3.0 | parts |
| (MHI 454 produced by Mikuni Sikisosha, 30% MEK dispersion) | | |
| Hindered amine stabilizer LS 770 | 0.5 | parts |
| (produced by Sankyo Life-Tech Co., Ltd.) | | |

| | |
|---|---|
| Copolymer having units | Amount as shown in Table 2 |

| | | |
|---|---|---|
| represented by formulae (1), (2) and (3) or surfactants | | |
| (each being shown in Table 2) | | |
| Cyclohexanone (bp. 155° C.) | 820 | parts |
| <<Protective layer coating solution>> | | |
| Polyvinyl alcohol AL06 | 95 | parts |
| (produced by Nippon Gosei Kagaku Co., Ltd.) | | |
| Copolymer of vinyl pyrrolidone VA64W | 5 | parts |
| (produced by BASF Co., Ltd.) | | |
| Surfactant Surfinol 465 | 0.5 | parts |
| (produced by Nisshin Kagaku Co., Ltd.) | | |
| Water | 900 | parts |

Compound A

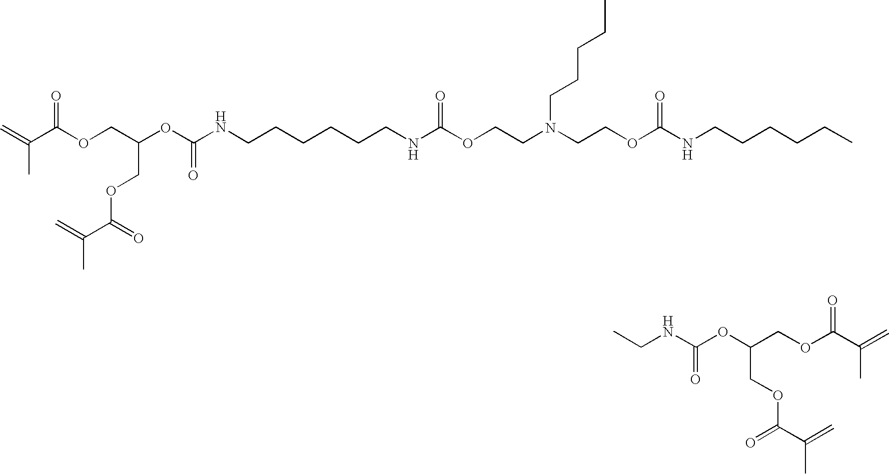

Sensitizing dye A

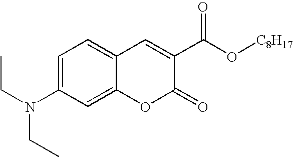

(Image Formation)

The above-obtained photopolymerizable planographic printing plate material samples were imagewise exposed at a resolution of 2400 dpi (dpi represents the dot numbers per 2.54 cm) employing a modified plate setter of Tigercat (produced by ECRM Co., Ltd.) installed with a 408 nm laser source with an output power of 30 mW.

The exposed printing plate material samples were processed, employing a CTP automatic developing machine (PHW 32-V produced by Technicagraph Co., Ltd.) having a pre-heating section upstream a developer tank, a pre-washing section for removing the oxygen-shielding layer before development, a developer tank charged with a developer described below, and a gumming tank charged with a gumming solution (a solution obtained by diluting GW-3, produced by Mitsubishi Chemical Co., Ltd., with water by a factor of 2) for protecting the surface of developed samples.

Herein, the pre-heating was carried out at 110±5° C. for 15 seconds. The heating temperature was measured employing a thermo label (produced by Nichiyu Giken Co., Ltd.) adhered on the roughened surface of the support on the light sensitive layer side.

<Composition of developer>

| | |
|---|---|
| Potassium silicate A | 8.0 parts |
| (an aqueous potassium silicate solution | |
| containing 25.5-27.5% by weight of SiO₂ and | |
| 12.5-14.5% by weight of K₂O) | |
| NEWCOL B-13SN (produced | 3.0 parts |
| by Nippon Nyukazai Co., Ltd.) | |
| Disodium ethylenediaminetetraacetate | 0.1 parts |
| dihydrate | |
| Potassium hydroxide | Amount giving pH 12.1 |

(Evaluation of Light Sensitive Planographic Printing Plate Material Samples)

The resulting light sensitive planographic printing plate material sample was evaluated as follows:

<Sensitivity 2>

Each of the planographic printing plate material samples was imagewise exposed as above to form a 100% solid image, while changing the exposure energy level, and then developed as described above to form a developed 100% solid image. Density of the developed solid image at each-exposure energy level was measured through a densitometer D196 (produced by GRETAG Co., Ltd.). herein, Exposure energy providing 90% of the maximum density of the developed solid image was defined as sensitivity 2, and represented in terms of μJ/cm².

<Dot Reproduction>

Small dot reproduction and large dot reproduction were observed on the developed printing plate material samples. Dot images with a screen line number of 200 at highlight portions were observed at a dot area interval of 1%, and the minimum dot area (%) where small dot images were reproduced was evaluated as a measure of small dot reproduction. Dot images with a screen line number of 200 at shadow portions were observed at a dot area interval of 1%, and the maximum dot area (%) where large dot images were reproduced was evaluated as a measure of large dot reproduction.

<Coatability>

Coatability was evaluated according to the following criteria:
A: No Marangoni was observed, the number of coating faults with a size of not more than 100 μm was less than 20, and no defects were observed.
B: Marangoni was observed, and the number of coating faults with a size of not more than 100 μm was from 20 to 100, but no major defects were observed.
C: Marked Marangoni was observed, the number of coating faults with a size of not more than 100 pm was more than 100, and major defects were observed.
   <Oxygen-shielding Layer Adhesion to Light Sensitive Layer>

Scratch test was carried out in order to evaluate adhesion of the oxygen-shielding layer to the light sensitive layer. The resulting planographic printing plate material sample obtained above was allowed to stand at 25° C. and 50% RH for 2 hours under a fluorescent lamp. After that, the sample obtained above was scratched at a speed 1000 mm/min. with a sapphire needle having a tip diameter of 0.1 mm through a scratch tester Heidon-18 produced by Heidon Co., Ltd., load, the weight changed from 0 to 100 g, being applied to the sapphire needle. The minimum load at which the protective layer was peeled from the light sensitive layer was measured five times, and the average was regarded as a measure of oxygen-shielding layer adhesion.
<<Sludge>>

Five hundred square meters of each sample were processed employing the developing machine described above, and after processing, sludge produced in the developing tank and sludge adhered on the developed sample were observed.

<Anti-sludge Contamination Properties>

(Ant-sludge Contamination Property 1)

The sludge produced was evaluated as a measure of ant-sludge contamination property 1 according to the following criteria:
A: The sludge was not adhered to the developed sample, which was not problematic.
B: The sludge was adhered to the developed sample in the developing tank, but removed in a washing section from the sample, which was not substantially problematic.
C: The sludge was adhered to the developed sample, causing contaminations at non-image portions.
   (Ant-contamination Property 2)

After Each sample was processed in the same manner as above, 100 ml of the developer was placed in a tightly sealed vessel and stored at 55° C. and 20% RH for 7 days. The resulting developer was filtered off to obtain a residue. The residue was dried at 70° C. for one day. The amount of the dried residue was represented in terms of g/liter and evaluated as a measure of ant-sludge contamination property 2.

<Pre-heating Latitude>

The exposed light sensitive planographic printing plate material sample was subjected to development treatment in the same manner as above, except that the preheating temperature was varied. Thus, a printing plate sample was obtained. Subsequently, printing was carried out employing the resulting printing plate sample as described below, and the maximum pre-heating temperature at which neither stain at non-image portions nor filling-up at shadow image portions was produced was determined.

The printing plate sample having an image with a screen line number of 175 was mounted on a press (DAIYA1F-1 produced by Mitsubishi Jukogyo Co., Ltd.), which was obtained by exposing the light sensitive planographic printing plate sample at an appropriate exposure amount, pre-heating the exposed sample at each temperature and developing in the same manner as above, and printing was carried out wherein a coat paper, printing ink (Soybean oil ink, Naturalith 100, produced by Dainippon Ink Kagaku Co., Ltd.), and dampening water (SG-51, H solution produced by Tokyo Ink Co., Ltd., Concentration: 1.5%) were used. Non-image portions and shadow portions of one thousandth print, after printing started, were compared with those of print obtained employing a printing plate sample obtained at a pre-heating temperature of 105° C. (as standard pre-heating temperature).

In this evaluation, the pre-heating section of the automatic developing machine was switched off. The planographic printing plate material sample was pre-heated in a separate heater in a safe-light room at an intended temperature for 30 seconds.

The results are shown in Table 2.

As is apparent from Table 2 above, the light sensitive planographic printing plate materials of the invention provide good coatability, an oxygen-shielding layer with excellent adhesion, high sensitivity, high dot reproduction, wide preheating latitude, and excellent anti-sludge contamination properties.

TABLE 2

| | | Copolymer in | | | | | | | | | | |
|---|---|---|---|---|---|---|---|---|---|---|---|---|
| | | the invention | | | | | | | | | | |
| | | or surfactant | | | | | | | | | | |
| Printing | | used | | | | | | | | | | |
| plate | | | Amount | | | | | | | | | |
| material | | | (parts | | | | | | | | | |
| sample | Support | | by | Performances | | | | | | | | |
| No. | used | Kind | weight) | a) | b) | c) | d) | f) | g) | x) | y) | Remarks |
| 7 | 3 | None | None | C | 40 | 7 | 90 | C | 6 | 10 | 110 | Comp. |
| 8 | 3 | F142D | 1 | B | 500 | 5 | 90 | C | 6 | 15 | 115 | Comp. |
| 9 | 3 | P1 | 1 | A | 40 | 5 | 95 | A | 2 | 50 | 140 | Inv. |
| 10 | 3 | P4 | 1 | A | 35 | 3 | 95 | A | 1 | 50 | 140 | Inv. |
| 11 | 3 | P7 | 1 | A | 35 | 3 | 95 | A | 0.7 | 70 | 145 | Inv. |
| 12 | 2 | P1 | 1 | A | 40 | 3 | 95 | A | 1.5 | 50 | 145 | Inv. |
| 13 | 2 | P4 | 1 | A | 35 | 3 | 95 | A | 0.9 | 50 | 150 | Inv. |
| 14 | 2 | P7 | 1 | A | 35 | 3 | 95 | A | 0.5 | 50 | 150 | Inv. |

Comp.: Comparative;
Inv: Inventive
a) Coatability;
b) Sensitivity 2 (μJ/cm²);
c) Small dot reproduction (%);
d) Large dot reproduction (%);
f) Ant-contamination property 1;
g) Ant-contamination property 2;
x) Oxygen-shielding layer adhesion;
y) Pre-heating latitude (° C.)

What is claimed is:

1. A light sensitive planographic printing plate material comprising a support and provided thereon, a negative working light sensitive layer, wherein the light sensitive layer contains a polymerizable ethylenically unsaturated compound, a photopolymerization initiator, a polymeric binder, a sensitizing dye, and a copolymer having a first unit represented by formula (1), a second unit represented by formula (2), and a third unit represented by formula (3), 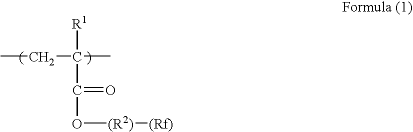
wherein R¹ represents a hydrogen atom or an alkyl group having a carbon atom number of from 1 to 3; R² represents a divalent linkage group, and Rf represents a perfluoroalkyl group or a perfluoroalkenyl group, 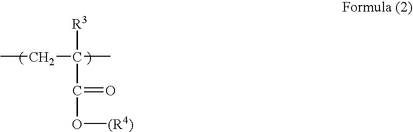
wherein R³ represents a hydrogen atom or an alkyl group having a carbon atom number of from 1 to 3; and R⁴ represents a substituted or unsubstituted alkyl group or a substituted or unsubstituted cycloalkyl group, 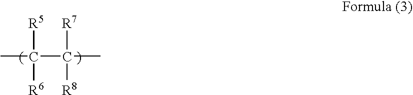
wherein R⁵, R⁶, R⁷ and R⁸ independently represent a hydrogen atom, a methyl group or R⁹, provided that at least one of R⁵, R⁶, R⁷ and R⁸ is R⁹, where R⁹ represents a carboxyl group, a sulfonic acid group, a carboxylate group, a sulfonate group, or a substituent having a carboxyl group, a sulfonic acid. group, a carboxylate group, a sulfonate group, —(C₂H₄O)pH, or —(C₃H₆O)qH, in which p and q independently represent an integer of from 1 to 50.

2. The light sensitive planographic printing plate material of claim 1, wherein the photopolymerization initiator is a biimidazole compound or an iron arene complex.

3. The light sensitive planographic printing plate material of claim 1, wherein the sensitizing dye has absorption maximum in the wavelength regions of from 350 to 450 nm.

4. The light sensitive planographic printing plate material of claim 1, wherein the sensitizing dye is a coumarin dye represented by the following formula (8), 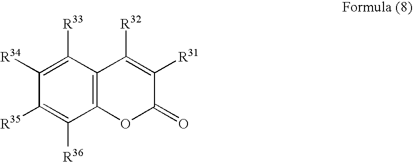
wherein R⁻, R³², R³³, R³⁴, R³⁵ and R³⁶ independently represent a hydrogen atom or a substituent.

5. The light sensitive planographic printing plate material of claim 1, further comprising an oxygen-shielding layer containing a hydrophilic polymer on the light sensitive layer, the oxygen-shielding layer being an outermost layer.

6. The light sensitive planographic printing plate material of claim 5, wherein the oxygen-shielding layer contains, as the hydrophilic polymer, polyvinyl alcohol having a saponification degree of from 90 to 100 mol %.

7. The light sensitive planographic printing plate material of claim 6, wherein the oxygen-shielding layer further contains polyvinyl pyrrolidone.

8. The light sensitive planographic printing plate material of claim 1, wherein the content of the first unit, the content of the second unit and the content of the third unit in the copolymer is from 30 to 50 mol %, from 20 to 40 mol %, and from 20 to 40 mol %, respectively.

9. The light sensitive planographic printing plate material of claim 1, wherein the content of the polymerizable ethylenically unsaturated compound is from 30 to 70% by weight, the content of the polymeric binder is from 15 to 70% by weight, the content of the sensitizing dye is from 0.1 to 20% by weight, and the content of the copolymer is from 0.01 to 10% by weight, each based on the weight of light sensitive layer, and the content of the photopolymerization initiator is from 0.1 to 20% by weight based on the weight of the ethylenically unsaturated compound.

10. A light sensitive planographic printing plate material comprising a support and provided thereon, a positive working light sensitive layer, wherein the light sensitive layer contains a photolytically acid generating agent, an acid decomposable compound, an infrared absorbing dye, and a copolymer having a first unit represented by formula (1), a second unit represented by formula (2), and a third unit represented by formula (3), 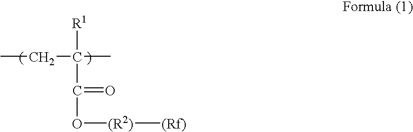
wherein R¹ represents a hydrogen atom or an alkyl group having a carbon atom number of from 1 to 3; R² represents a divalent linkage group, and Rf represents a perfluoroalkyl group or a perfluoroalkenyl group, 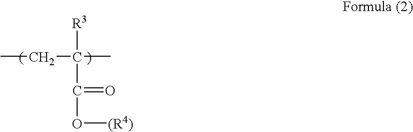
wherein R³ represents a hydrogen atom or an alkyl group having a carbon atom number of from 1 to 3; and R⁴ represents a substituted or unsubstituted alkyl group or a substituted or unsubstituted cycloalkyl group, 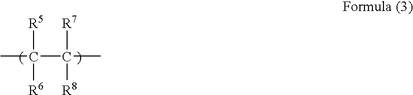
wherein R⁵, R6, R⁷ and R⁸ independently represent a hydrogen atom, a methyl group or R⁹, provided that at least one of R⁵, R⁶, R⁷ and R⁸ is R⁹, where R⁹ represents a carboxyl group, a sulfonic acid group, a carboxylate group, a sulfonate group, or a substituent having a carboxyl group, a sulfonic acid group, a carboxylate group, a sulfonate group, —(C₂H₄O)pH, or —(C₃H₆O)qH, in which p and q independently represent an integer of from 1 to 50.

11. The light sensitive planographic printing plate material of claim 10, wherein the content of the first unit, the content of the second unit and the content of the third unit in the copolymer is from 30 to 50 mol %, from 20 to 40mol %, and from 20 to 40 mol %, respectively.

12. The light sensitive planographic printing plate material of claim 10, wherein the photolytically acid generating agent is selected from the group consisting of a salt of diazonium, phosphonium, sulfonium or iodonium ion with BF₄⁻, PF6⁻, SbF₆⁻SiF₆²⁻or ClO₄⁻, an organic halogen-containing compound, and o-quinonediazide sulfonylchloride.

13. The light sensitive planographic printing plate material of claim 10, wherein the light sensitive layer further contains a polymeric binder.

14. The light sensitive planographic printing plate material of claim 13, wherein the content of the photolytically acid generating agent is from 0.1 to 20% by weight, the content of the acid decomposable compound is from 5 to 70% by weight, the content of the infrared absorbing dye is from 0.5 to 10% by weight, the content of the copolymer is from 0.01 to 10% by weight, and the content of the polymeric binder is from 15 to 70% by weight, each based on the weight of the light sensitive layer.
